(19) United States
(12) Patent Application Publication
(10) Pub. No.: US 2011/0012336 A1
(43) Pub. Date: Jan. 20, 2011

(54) SECURITY SHEET INCLUDING A STRIPPABLE RIBBON FOR EXPOSING MASKED INFORMATION, AND METHOD FOR MAKING SAME

(75) Inventor: Henri Rosset, Le Pin (FR)

Correspondence Address: Oliff & Berridge, PLC, P.O. Box 320850, Alexandria, VA, 22320-4850, US

(73) Assignee: ARJOWIGGINS SECURITY, ISSY LES MOULINEAUX (FR)

(21) Appl. No.: 12/867,988

(22) PCT Filed: Feb. 26, 2009
(86) PCT No.: PCT/FR09/50307

§ 371 Date: Sep. 13, 2010

(30) Foreign Application Priority Data
Feb. 26, 2008 (FR) 0801021

(51) Int. Cl. B42D 15/00; D21H 21/40

(52) U.S. Cl. 283/67; 283/103; 283/101; 162/140; 162/134

(57) ABSTRACT

A security sheet that includes an information to be exposed and a preferably fibrous substrate in which is preferably totally embedded a ribbon that has a surface A and a surface B and is strippable along the surface B thereof, the information to be exposed being carried by and/or opposite the surface B of the ribbon, a method for making said security sheet, and a security document or article including such a sheet.

The invention relates to a security sheet comprising an item of information to be revealed and a substrate with a peelable strip for revealing the item of information and to the method for manufacturing said security sheets and the documents comprising this sheet. The invention also relates to a method for revealing an item of information.

The security documents are produced from notably fibrous materials and can notably be banknotes, identity cards, passports, driver's licenses, visas, checks, coupons, transportation tickets or tickets for entry to a cultural or a sporting event, gaming tickets, notably for games of chance such as scratch cards, a lottery, prize draw tickets.

Very often the games of chance tickets use a solution by scratching to reveal an amount to be won or any other information relating to the amount to be won or if the ticket is a winning or a losing ticket. A portion of the ticket surface comprises a layer of opaque ink that can be scratched off which masks this information, so that when someone scratches off this layer they discover the information. Moreover, in certain cases, such as for example for “Le Millionnaire” tickets offered by the Société Francaise des Jeux (France's Lottery Authority), a barcode system is used to validate the winning ticket. However, these products have a certain risk of being falsified because the opaque layer can be removed, and then the information that has become accessible is modified and a new layer can be reapplied over the information zone.

Application GB 2 331 270 describes an information backing element comprising a transparent upper layer having a precut zone furnished with printing, and a nontransparent lower layer provided with scrambling means that can be seen through the upper layer and that make it impossible to see the printing of the upper layer. The printing is seen by detaching the precut zone. The necessary choice of an upper layer that is transparent and of specific scrambling means for preventing the information from being read is a constraint. Moreover, such an information backing element does not provide sufficient security against any falsification attempt, the precut zone being able to be replaced on the upper layer after having been detached therefrom.

A first object of the invention is to solve the drawbacks of the prior art and to propose a new means of revealing information in the context of a gaming ticket or a communication or promotion backing element or in any other application. A second object is to propose also a means of masking such information.

Accordingly, the invention proposes to provide a security sheet comprising an item of information to be revealed and a backing element formed of a preferably fibrous substrate, in which is preferably totally incorporated a preferably fibrous strip, having a face A and a face B, said strip being able to be peeled along said face B, and said item of information being carried by and/or facing said face B.

When the strip is detached from the sheet by virtue of its peelability on its face B where it is separated from the substrate, it is possible to read the information on the face B of the strip and/or on another portion, situated facing the face B of the strip, of the document or article comprising said sheet. In the case of a lottery ticket for example, the information may indicate the amount of the prize won. The fact that the strip is incorporated into the substrate increases the security of the sheet because any attempt at abnormal removal of the strip will cause visible damage to said substrate. Therefore, because of the visible damage to the substrate, notably on its portions in contact with the edges or the faces of the strip, during an attempt to remove the strip, it will be impossible for a falsifier to identically replace the strip within the substrate. The invention therefore provides additional security and an easy means of detecting an attempt to falsify the security sheet.

The strip may be partially or totally incorporated into the substrate. Also the strip is distinct from the substrate. In particular, the strip does not constitute a portion of the substrate.

In order to have a good grip of the strip in the substrate while having good peelability of the strip, preferably said security sheet according to the invention is such that the level of cohesion Cb between the face B of the strip and the substrate is less than the level of cohesion Ca between the face A and the substrate, preferably this level Cb being less than or equal to 50% of the level Ca. This makes it possible to have relatively weak adhesion between the face B of the strip and the substrate in order to be able to carry out the peeling without damaging the interface of the face B of the strip and of the substrate in contact with it. Moreover, the adhesion between the face A of the strip and the substrate is relatively higher which makes it possible to cause the strip to hold well to the substrate and to facilitate the removal of the strip with the material of the substrate situated above this face A in a relatively clean manner. It is notably possible to measure these levels of cohesion by measuring the internal Scott Bond cohesion as described below.

Preferably, the security sheet according to the invention is such that the face A of said peelable strip comprises an adhesive chosen from a heat-reactivateable adhesive or a heat-seal adhesive. In particular, said adhesive of the face A comprises poly(vinyl acetate).

According to a particular case, the face A of the peelable strip of the security sheet according to the invention comprises an adhesive as defined above while the face B of said peelable strip is not adhesive-coated.

Preferably, in order to have a good hold of the strip in the substrate while having good peelability of the strip, the security sheet according to the invention is characterized in that said strip comprises, on its face B, an adhesive agent of low adhesive power and, on its face A, an adhesive which provides a fairly strong cohesion between the strip and the substrate. In the context of the invention, an “adhesive agent of low adhesive power” is an adhesive agent which provides weak cohesion, marked “Cb”, between the face B of the strip and the substrate, while “adhesive” designates a compound which gives a fairly strong cohesion, marked “Ca”, between the face A of the strip and the substrate. Therefore, the adhesive used on the face A of the strip gives stronger cohesion between the strip and the substrate than the adhesive agent of low adhesive power that is present on the face B of the strip. As explained above, this allows a good hold of the strip in the substrate and good peelability.

Preferably, the adhesive agent of low adhesive power that is present on the face B of the strip is characterized in that it provides a level of cohesion Cb between said face B of the strip and the substrate that is lower than or equal to 50% of the level of cohesion Ca between the face A of the strip and the substrate. The presence of an adhesive agent of low adhesive power at the interface between the face B of the strip and the substrate notably makes it possible to limit possible phenomena of fluffing when the strip is detached from the sheet.

Preferably in order to facilitate detaching the strip from the sheet, said security sheet according to the invention is characterized in that said sheet comprises a peeling starter made by a cut line halfway into the thickness of the sheet, crosswise to the strip, to a depth equal to at least the thickness of the portion of the substrate covering the face A of the strip plus the thickness of said strip. “Crosswise” means that it is made in the breadthwise direction of the strip; it may be orthogonal to the strip or slantwise.

Preferably also according to the invention, said starter has a width equal to the width of said strip.

Preferably, the security sheet according to the invention comprises a peeling tab in order to facilitate the detachment of said strip, in particular said tab is a part (sticker) that is adhesive-coated on a portion of one of its faces which is placed on said strip, in particular at the peeling starter of the strip. The adhesive-coated portion of one of the faces of the tab which may represent, for example, half of the total surface area of said face, makes it possible to attach said peeling tab flush with the strip, the delimitation between the adhesive-coated portion and the non-adhesive-coated portion of said tab being situated in particular at the peeling starter of the strip.

More particularly, the security sheet according to the invention is such that said strip extends from one edge to the other of said sheet, in particular between two opposite edges of said sheet.

Preferably, the security sheet according to the invention is such that said strip and/or said substrate has a fibrous composition based on fibers chosen from cellulose fibers, in particular cotton fibers, and/or natural organic fibers other than cellulose and/or synthetic fibers and/or possibly mineral fibers, preferably based on hydrophilic fibers, preferably said composition comprises at least 50% by weight of cellulose fibers.

The synthetic fibers can for example be polyester or polyamide fibers.

Preferably, said fibers are hydrophilic, notably so as to develop connections between the strip and the substrate.

According to a particular case of the invention, said security sheet is such that said substrate and said strip are based on the same fibers, in particular have the same fibrous composition, which preferably comprises at least 50% by weight of cellulose fibers. The fact that the substrate and said strip are based on the same fibers (same kind) and preferably in the same proportion allows a good affinity between the two components and limits the visibility of the strip in the substrate and may also be a means of authentication.

According to a particular case of the invention, said strip has more than 30% tensile strength when wet, notably so as not to cause problems when it is inserted into said security sheet. The tensile strength when wet is measured by dividing the value of the tensile strength when wet measured according to Standard NF Q 03.056 by the tensile strength when dry measured according to Standard NF EN ISO 1924. This strength when wet can notably be provided by the addition of a wet strength agent, for example such as a polyamine-amide-epichlorohydrin (PAAE) resin.

According to the invention, said security sheet is such that said strip has a width of between 4 and 60 mm, preferably between 5 and 30 mm and more preferably between 10 and 20 mm.

According to the invention, said security sheet is such that said strip has a thickness of between 20 and 120 μm, preferably between 30 and 80 μm and more preferably between 45 and 55 μm.

Said strip may be calendered. This calendering is carried out notably in order to minimize the additional thickness created by the insertion of said strip into the substrate, moreover calendering of the strip promotes good peelability of the face B.

Preferably according to the invention, said security sheet is such that said substrate comprises a fibrous single ply or several fibrous layers, in particular two layers. A “ply” is a fibrous layer produced continuously on a paper machine; in the case of two plies, the plies are brought together in the wet state.

According to a particular case of the invention, said sheet, in particular said strip and said substrate, possibly at least one of the layers of said substrate, have different colors. This gives higher security due to the presence of different colors in one and the same security sheet.

Preferably according to the invention, said strip is white, notably when the information will be printed on its face B, the printing then being clearly legible.

According to a particular case of the invention, said substrate is opaque, in particular black. More particularly in the case of a substrate comprising two layers, at least the layer adjacent to the face B of the strip is opaque, preferably black.

According to a particular case of the invention, said strip is opaque.

The opacity of the strip and/or of the substrate makes it possible to mask the information to be revealed.

According to a particular case of the invention, said security sheet also comprises an opaque layer, preferably white, at least on one of the faces of said sheet, in particular on its face opposite said face B of said strip, preferably on both its faces. This layer may make it easier to print on the sheet and/or to mask the information. It is possible to use a layer of script print comprising fillers such as titanium dioxide and calcium carbonate (approximately 15% by weight of a latex for example of styrene-butadiene), the layer weight per face being from 8 to 12 g/m² when dry.

According to a particular case of the invention, said security sheet comprises another sheet material at least partly carrying said item of information and assembled to said backing element so that said item of information is facing the face B of said strip. The information may advantageously be partly carried on the face B of the strip and/or a zone of the substrate facing the strip and on a portion of this other sheet material; this complementarity improves the security of the sheet.

More particularly according to the invention, said security sheet is such that said sheet material is laminated to said backing element with an adhesive, for example a polyurethane-based adhesive.

According to the invention, said sheet material is a fibrous sheet, in particular a cardboard, or a plastic sheet. It may have a relatively high basis weight, of the order of 350 g/m² in order to have a sufficient opacity to mask the information to be revealed.

According to another particular case of the invention, the substrate is translucent and a portion of said information is situated on the substrate and/or on the other sheet material, opposite the face B of the strip, so as to make it possible to see the information through the substrate when the strip has been removed; said information will then be masked by an opaque layer on the face or faces of the substrate comprising it, this layer covering the information, or possibly it will be masked by said sheet material.

Preferably, said security sheet according to the invention is such that said strip and/or said substrate and/or said sheet material comprises at least one security element. Possibly, said item of information also comprises a security element.

Said security element will be chosen according to the field of application of said sheet. In the case of a lottery ticket, fluorescent security fibers may be used in the substrate and/or the strip. This security element may be chosen more generally from many known elements such as notably tracers that can be detected optronically, electrically, magnetically, electromagnetically, by ultrasound and in particular nanometrically, security fibers that are notably metallic, magnetic (with soft and/or hard magnetism), or absorbent or excitable in the ultraviolet (UV), the visible or the infrared (IR) and in particular the near infrared (NIR), flakes, pigments or pigment agglomerates that can notably be absorbed or excited under laser illumination or in the ultraviolet (UV), the visible or the infrared (IR), in particular the near infrared (NIR), chemical or biochemical antifalsification and/or authentication and/or identification reactants that can in particular react with at least one falsification and/or authentication and/or identification agent respectively, and their combinations.

Another security element can be a watermark.

The invention also relates to the method for manufacturing the security sheet, notably in the situation in which the strip is a fibrous strip such as a paper.

More precisely, the invention provides a method for manufacturing a security sheet as described above, comprising at least one item of information to be revealed and a backing element formed of a preferably fibrous substrate, into which a preferably fibrous strip is incorporated, having a face A and a face B, that can be peeled along said face B, said item of information being carried by and/or facing said face B, said method comprising at least the following steps:
in a first step, the preferably fibrous strip is manufactured,
in a second step, said backing element is manufactured according to a paper-making method, by inserting said preferably fibrous strip partly wet into said preferably fibrous substrate in formation.

The insertion of said security strips into said substrate may notably be carried out according to the known methods of inserting plastic security threads.

Said security sheet obtained according to the invention comprises at least one strip that can notably be relatively wide.

Said strip can be inserted partly wet en masse into said substrate.

According to one particular mode of the invention, the method uses a paper machine that is fitted with at least one round form, and said strip is inserted en masse into the form tank of said round form before or shortly after the beginning of the draining of the composition forming said substrate of the sheet.

According to another mode, the method can use a paper machine which is fitted with at least one flat table, and said strip is inserted en masse on top of said flat table during the draining of the composition forming said substrate of the sheet.

According to another particular mode of the invention, said substrate comprises at least two plies, and said strip is inserted before the assembly in the wet state of two successive plies, that is to say according to the usual paper-making method, before the strip-plies of the substrate assembly is dried.

According to another particular mode of the invention, said strip is incorporated by lamination between two fibrous layers of said substrate of said security sheet.

According to a particular mode of the method of the invention, a cut zone is produced, crosswise to the strip, halfway through in at least the thickness of the portion of the substrate covering the face A of said strip and up to the whole of the thickness of said strip in order to create a peeling starter, preferably along the whole width of said strip. The material opposite the face B of the strip is not cut. A notch is obtained which makes the subsequent grasping of the strip easier, for example with the aid of a nail or a tip of a stylet in order to lift it and detach it from the sheet.

More particularly, it is possible to cut said zone by cutting with a knife, for example by “kiss cutting”, with a rotary knife or with a laser.

Preferably, in order to make it easier to pick up the strip in order to lift it and detach it, in the method for manufacturing said security sheet according to the invention, an adhesive-coated part (sticker) is applied to said sheet, at least partially superposed on the line of the cut at the peeling starter, in order to make a peeling tab. The sticker must be applied in a zone of the sheet facing the strip in order to allow the latter to be peeled. In a particular case, the sticker may comprise security elements and in particular visual elements such as optically variable elements, notably holograms, liquid crystals, interferential pigments or mirror-effect structures, dielectric layers and their combinations. The adhesive-coated part (sticker) may be a polyester backing element furnished with an adhesive or heat-seal layer.

In the first step of the manufacturing method, in order to obtain said strip, it is possible to manufacture first a fibrous sheet, preferably of low basis weight, notably between about 15 and 90 g/m², according to a usual paper-making method, that is to say by draining a suspension of fibers, comprising possibly fillers and additives that are conventional in paper-making and the specific security elements, and then pressing and drying the fibrous mat obtained.

According to a preferred mode of the invention, in the step for manufacturing the strip, the strip is manufactured by forming a fibrous sheet in a paper-making manner from a suspension of fibers, a composition of a heat-reactivateable adhesive or a heat-seal adhesive is applied to one of the faces of said fibrous sheet, in particular said adhesive is polyvinyl acetate)-based, the sheet is dried, it is cut into strips, the face with said adhesive forming the face A of said strip and the other face forming its face B. The adhesive can be applied outside the paper machine, for example by heliogravure.

Also preferably, according to one mode of the invention, an adhesive agent with low adhesive power is applied, before or after the coating of said adhesive, to the face of the fibrous sheet opposite to the face receiving said adhesive, in particular such that thereafter the level of cohesion Cb between the face B of the strip and the substrate is less than the level of cohesion Ca between the face A and the substrate, preferably this level Cb being less than or equal to 50% of the level Ca.

According to a preferred mode of the invention, said item of information is printed on the face B before the strips are cut, even before the application of the adhesive.

According to a particular mode of the method for manufacturing said sheet, a preferably white opaque layer is applied to said backing element, in particular to the face opposite the face B, preferably to both its faces.

According to a particular mode of the method for manufacturing said sheet, said item of information is at least partly printed onto another sheet material and then said sheet material is laminated with the substrate-strip backing element, and such that the face B of said strip is facing said item of information.

The invention also relates to a security document or an article comprising an item of masked information to be revealed, characterized in that it comprises a security sheet with a peelable strip as described above.

More particularly according to the invention, said security document or article is chosen from a gaming ticket, particularly for a lottery, a sheet or an envelope with acknowledgement of receipt, a security label, a packaging element, particularly a packaging element for medication or for foodstuffs or for cosmetics or perfumes or for electronic parts or for spare parts, a sheet used in the medical or hospital field, particularly a paper used to produce sterilization packaging elements.

In the case of a sheet or an envelope with acknowledgement of receipt, said strip forms the acknowledgement of receipt that can be returned to the sender.

The invention also relates to a method for revealing a masked item of information of a security document or of an article which is characterized in that a document or article is used comprising a peelable strip as described above and in that said strip is peeled off by separating it from the substrate at its face B and then the item of information is read on the strip and/or on a zone of the document or article that was facing said strip.

It is possible, by virtue of a peeling starter, to lift the strip with the nail and then detach it by peeling it or, if there is a peeling tab, to use this tab to lift and detach the strip.

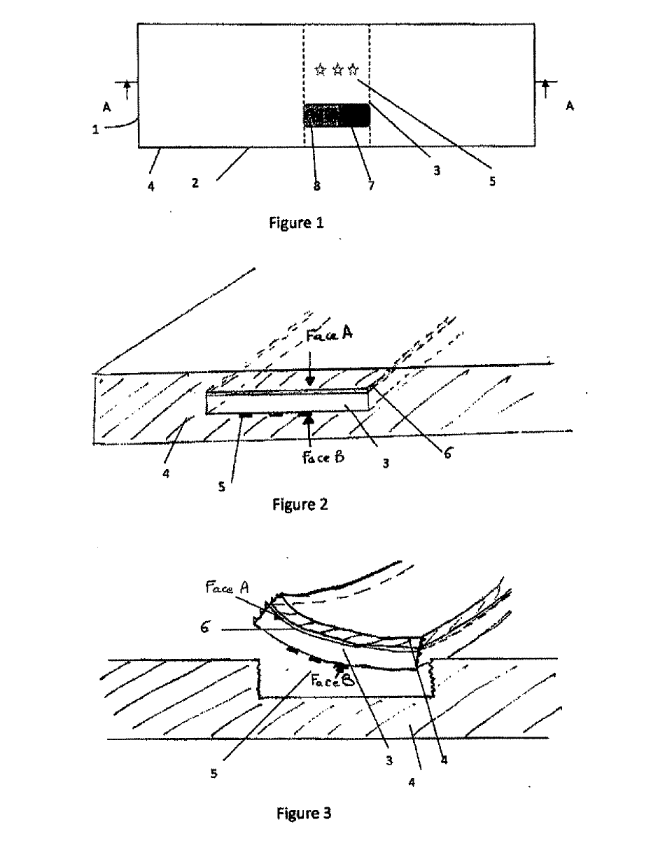

Examples of construction and embodiments of sheets according to the invention are presented below in relation to appended FIGS. 1 to 11. The various elements are not to scale for the purpose of greater clarity of the figures.

FIG. 1 represents a front view of a security sheet 1 according to the invention.

FIG. 2 represents a section in the thickness along (AA), at the information 5, with perspective, of the security sheet 1 shown in FIG. 1.

FIG. 3 represents a view of the sheet 1 as in FIG. 2, once the strip 3 has been peeled off.

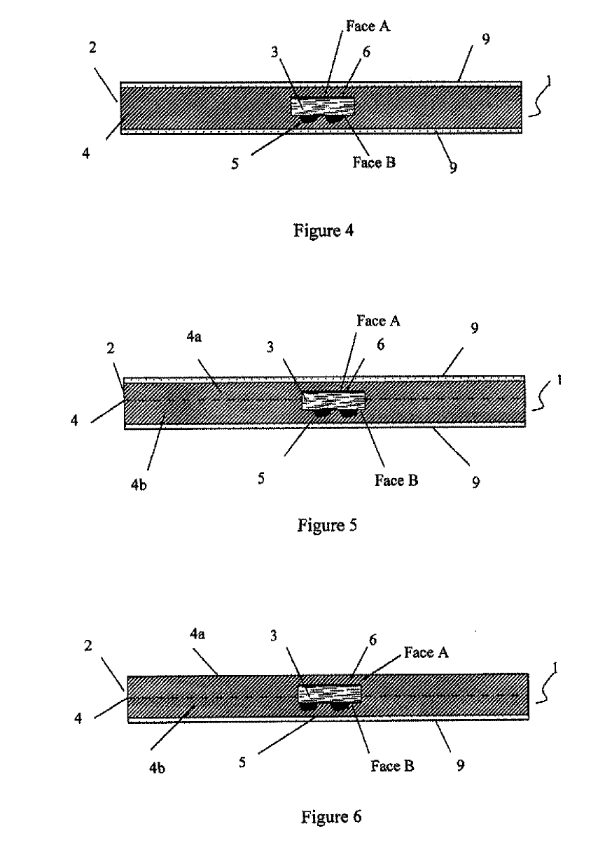

FIG. 4 represents a section in the thickness at the information 5 of another security sheet 1 according to the invention.

FIG. 5 represents a section in the thickness at the information 5 of another security sheet 1 according to the invention.

FIG. 6 represents a section in the thickness at the information 5 of another security sheet 1 according to the invention.

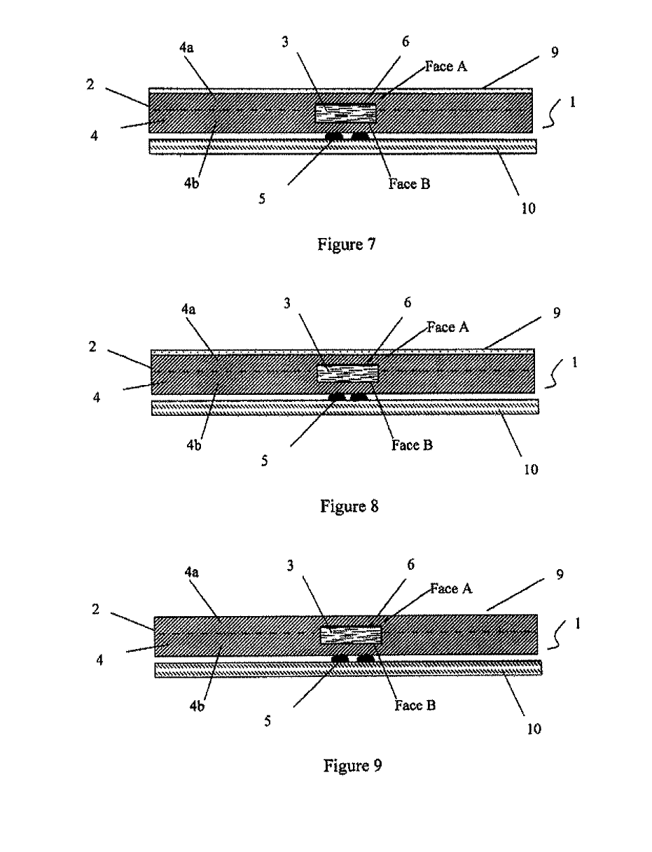

FIG. 7 represents a section in the thickness at the information 5 of another security sheet 1 according to the invention.

FIG. 8 represents a section in the thickness at the information 5 of another security sheet 1 according to the invention.

FIG. 9 represents a section in the thickness at the information 5 of another security sheet 1 according to the invention.

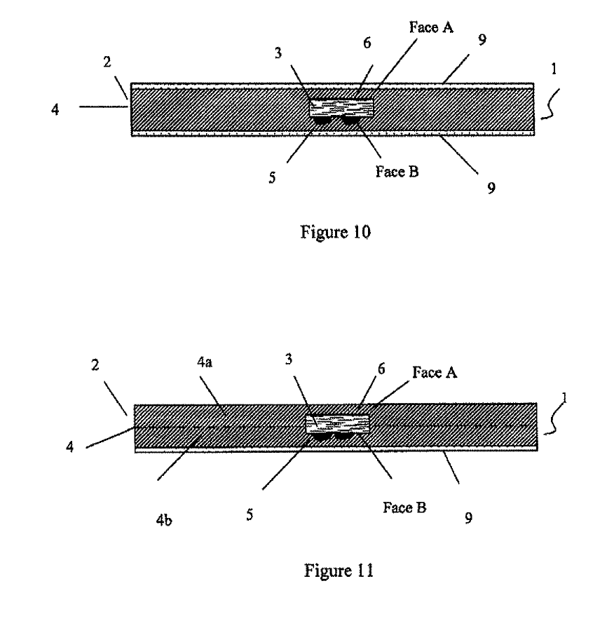

FIG. 10 represents a section in the thickness at the information 5 of another security sheet 1 according to the invention.

FIG. 11 represents a section in the thickness at the information 5 of another security sheet 1 according to the invention.

FIG. 1 represents a security sheet 1 seen from the front comprising a backing element 2 consisting of an opaque substrate 4 and a peelable opaque strip 3, a peeling starter 7 and an adhesive-coated part such as a peeling tab 8. An item of information 5 to be revealed is carried by the strip 3.

FIG. 2 represents a section in the thickness along (AA), at the information 5, with perspective, of the sheet 1 represented in FIG. 1. The information 5 is carried by the face B of the strip 3, opposite to the face A which comprises an adhesive layer 6.

FIG. 3 represents a view of the sheet 1 according to FIG. 2, once the strip 3 has been peeled off. The strip 3 is separated from the substrate 4 at its face B and reveals the information 5 that can therefore be read.

FIG. 4 represents a security sheet 1, seen in section, comprising a backing element 2 consisting of a white single-layer substrate 4 which incorporates a white peelable strip 3, an adhesive layer 6 on the face A of the strip 3 and an item of information 5 to be revealed carried on the face B of the strip 3. A white pigmented opaque layer 9 is applied to each of the faces of the substrate 4 so as to prevent the information 5 carried by the strip 3 from being read by showing through.

FIG. 5 represents a security sheet 1, seen in section, comprising a backing element 2 consisting of a fibrous substrate 4 comprising two plies 4a and 4b, the plies 4a and 4b being white, a white-paper peelable strip 3 situated between said plies, an adhesive layer on the face A of the strip 3 and an item of information 5 to be revealed carried on the face B of the strip 3. A white pigmented opaque layer 9 is applied to each of the faces of the substrate 4 so as to prevent the information 5 carried by the strip 3 from being read by showing through. An advantage of the structure of FIG. 5 is that it ensures a good entanglement of the strip 3 in the fibrous mat of the substrate 4.

FIG. 6 represents a security sheet seen in section comprising a backing element 2 consisting of a substrate 4 comprising two plies 4a and 4b, the plies 4a and 4b being white, and a white, opaque and peelable strip 3, an adhesive layer 6 on the face A of the strip 3 and an item of information 5 to be revealed carried on the face B of the strip 3. A white pigmented opaque layer 9 is applied to the face of the ply 4b so as to prevent the information 5 carried by the strip 3 from being read by showing through. Because of the difference in opacity between the substrate 4 and the opaque strip 3, the strip 3 will be visible in reflection on the side of the ply 4a, which may be advantageous for marking this strip 3 and its peeling direction.

FIG. 7 represents a security sheet 1 seen in section comprising a backing element 2 consisting of a substrate 4 comprising two plies 4a and 4b, the plies 4a and 4b being white and translucent, a white and peelable strip 3 situated between said plies, and an adhesive layer 6 on the face A of the strip 3. The face of the backing element 2, corresponding to the outer face of the ply 4b, is laminated onto an opaque sheet material 10 which comprises the item of information 5 to be revealed that is carried on its laminated inner face. The item of information 5 is marked in a zone opposite the strip 3. A white pigmented opaque layer 9 is applied to the face corresponding to the ply 4a. When the strip 3 is removed, it is possible to see the item of information 5 through the ply 4b of the residual substrate in the peeling zone.

The production of the sheet according to FIG. 7 is flexible because it does not require a cut at the marking of the strip 3 and allows customization on request of the material 10 to be laminated. The advantage of this embodiment lies in the flexibility of customization of the finished document.

FIG. 8 represents a security sheet 1 seen in section comprising a backing element 2 consisting of a substrate 4 comprising two plies 4a and 4b, the ply 4a being black and the ply 4b being translucent, a white and peelable strip 3 situated between said plies, and an adhesive layer 6 on the face A of the strip 3. The face of the backing element 2, corresponding to the outer face of the ply 4b, is laminated to an opaque sheet material 10 which comprises the item of information 5 to be revealed on its laminated face. The item of information 5 is marked in a zone facing the strip 3. A white pigmented opaque layer 9 is applied to the face of the ply 4a so as to promote good printability of the backing element 2 and to mask the background coloring of the ply 4a. The advantage of this solution is to allow a perfect camouflage of the strip 3 within the sheet 1.

FIG. 9 represents a security sheet 1 seen in section comprising a backing element 2 consisting of a substrate 4 comprising two plies 4a and 4b, the ply 4a being colored blue and opaque, the ply 4b being colored pink and translucent, a strip 3 colored green, that is peelable and situated between said plies, and an adhesive layer 6 on the face A of the strip 3. The face of the backing element 2, corresponding to the outer face of the ply 4b, is laminated to an opaque sheet material 10 which comprises the item of information 5 to be revealed on its laminated face. The item of information 5 is marked in a zone facing the strip 3. The sheet material 10 is for example a sheet of opaque cardboard having a basis weight of 340 g/m².

When the strip is peeled off, it is possible to see the item of information 5 through the ply 4b of the remaining substrate.

The advantage of such a sheet—shown in FIG. 9—is to provide an additional level of security based on the combination of three colors in the sheet 1 (in this instance blue, pink, green) which can be observed on the edge of the sheet 1 and/or when the strip 3 is peeled off.

FIG. 10 represents a security sheet 1 seen in section comprising a backing element 2 consisting of a fibrous opaque substrate 4 which is black in color, and a strip 3 made of white paper and peelable, inserted en masse during the formation of said substrate 4, an adhesive layer 6 on the face A of the strip 3 and an item of information 5 to be revealed carried by the face B of the strip 3. A white opaque pigmented layer 9 is applied to the two faces of the backing element 2 so as to promote good printability of the backing element 2 and to mask the background coloring of the substrate 4.

The advantage of this solution is that it allows a perfect camouflaging of the strip 3 within the sheet 1.

FIG. 11 represents a security sheet 1 seen in section comprising a backing element 2 consisting of a substrate 4 comprising two plies 4a and 4b, the ply 4a having the natural color of the paper and the ply 4b being opaque and black in color, and a strip 3 made of white, opaque paper and peelable, situated between said plies, an adhesive layer 6 on the face A of the strip 3 and an item of information 5 to be revealed carried by the face B of the strip 3. A white opaque pigmented layer 9 is applied to the outer face of the ply 4b so as to mask the coloring of the ply 4b and to promote good printability of the backing element 2.

A layer, not shown in these figures, of an adhesive agent of low adhesive power can be present on the face B of the strip 3.

The strips and substrates can notably be manufactured based on cellulose fibers in a paper-making manner as described in the text; in the case of translucent substrates or strips, it is possible to use, for example, very refined fibers.

Described below is a possible detailed embodiment of a sheet according to the invention with reference to FIGS. 1 to 3.

Consideration is given to the production, on a round-form paper machine, of a security sheet 1 formed of a backing element 2 comprising a peelable opaque strip 3 made of paper having a face A and a face B on which there is an item of information 5 to be revealed and incorporated in an opaque fibrous substrate 4.

### Manufacture of the Opaque Strips 3

An opaque white paper sheet is manufactured on a paper machine with a flat table from an aqueous suspension of refined cellulose fibers of the order of 30° SR, and the fibrous mat obtained is pressed. Off the machine, the user applies to one of the faces of this sheet, by heliogravure, an aqueous heat-seal adhesive coating 6 based on poly(vinyl acetate) marketed under the name of MOWILITH DC by the CELANESE company; this treated face will form the face A of the strip. Then the fibrous mat thus treated is dried. When dry, said sheet thus obtained has a basis weight of 45 g/m², the weight of the deposited adhesive layer 6 being 5 g/m² in dry weight. Printed onto said sheet, by inkjet, with a black ink, are stars which constitute the item of information 5 to be revealed.

This produces a sheet which is then cut into strips 3 1.5 cm wide. The strips 3 are wound onto a reel.

According to a variant, it is possible to print the strips after they are cut.

### Manufacture of the Backing Element 2 of the Security Sheet 1 Comprising a Peelable Strip 3

An opaque white fibrous substrate 4 is manufactured from a suspension of cellulose fibers in an aqueous medium containing white mineral fillers on a round-form paper machine into which said strips 3 are incorporated en masse by being inserted into the form tank of the round form. The substrate 4—strip 3 assembly forming the backing element 2 is drained, pressed and dried.

Then a notch is made in the sheet, at the level of the strip 3, by cutting with a knife (“kiss-cutting”) so as to cut, in the thickness, the material above the strip 3, adjacent to the face A of the strip 3, and said strip 3 in its thickness (without cutting the material beneath the strip 3, adjacent to the face B) in order to form a peeling starter 7, this notch therefore being crosswise and having the width of the strip 3. An adhesive-coated part called a “sticker” is affixed at the peeling starter 7 on the sheet in order to make a peeling tab 8.

This produces a sheet 1 according to the invention having a construction corresponding to FIGS. 1 and 2.

In order to assess the peelability of the strip 3, the internal cohesion is measured in Scott Bond units (according to Standard TAPPI UM 403) of the security sheet 1 on the one hand at the strip 3 and on the other hand beside the strip 3 in the vellum portion of the sheet. At the vellum (the portion of the substrate 4 outside the strip), it is 378. At the strip 3, there is a break at the interface between the non-adhesive-coated face of the strip (face B) and the substrate 4; the internal cohesion there is 70.

Said item of information 5 is masked by the opaque strip 3 and substrate 4.

It is then possible to manufacture a lottery ticket by laminating the face of the sheet 1 that does not have the peeling starter 7 with another pre-printed sheet and then cutting the sheet in formats appropriate for manufacturing lottery tickets.

To reveal the masked item of information 5, in this instance the number of stars, the strip 3 is pulled with the aid of the tab 8 which detaches along its face B cleanly from the substrate 4 and the item of information 5 is read on the strip 3 that has been removed (see FIG. 3).

According to a variant of this embodiment, a security sheet is manufactured as described above but, during the manufacture of the strip, applied to one face of the sheet used to make the strips (namely the face B) is an adhesive agent of low adhesive power based on polyurethane in the form of an aqueous dispersion marketed under the name of Collano DH9044 by the COLLANO company by a process of heliogravure, and, by the same process, applied to the other face of the strip (namely the face A) is the aqueous, poly(vinyl acetate)-based heat-seal adhesive marketed under the name of MOWILITH DC by the CELANESE company.

At the vellum, the internal cohesion in SCOTT BOND units is 400 while at the strip, at the interface between the weakly adhesive-coated face of the strip (face B) and the substrate, the internal cohesion is 90.

Described below is a possible embodiment of a sheet according to the invention with reference to FIG. 11. According to this mode, opaque strips 3 are produced as described in the previous mode, the item of information to be revealed being printed on the face B of the strips 3. The substrate 4—strip 3 backing element 2 is made according to a paper-making method on a machine with two round forms in order to form two fibrous plies 4a and 4b between which the strip 3 is inserted, all of the foregoing being assembled in the wet state. The two plies are different; the ply 4b which will be opposite the face B of the strip 3 is black opaque (by the addition of black colorant to the cellulose fibers) and the other ply 4a, opposite the face A of the strip 3, has the natural color of a paper. This provides a backing element 2 having a two-color substrate 4, the black ply 4b masking the item of information 5 to be revealed on one side, the opaque strip 3 masking it on the other side. An opaque white pigmented layer 9 is applied to the black face (ply 4b) of the backing element 2, possibly on each of the faces of the backing element 2 in order to mask the color of the ply 4b and have good printability.

1. A security sheet comprising an item of information to be revealed and a backing element formed of a fibrous substrate, in which is incorporated a fibrous strip, having a face A and a face B, said strip being able to be peeled along said face B, and said item of information carried by and/or facing said face B of the strip.

2. The sheet as claimed in claim 1, wherein said strip can be peeled so that the level of cohesion Cb between the face B of the strip and the substrate is less than the level of cohesion Ca between the face A and the substrate.

3. The sheet as claimed in claim 1, wherein the face A of said peelable strip comprises an adhesive chosen from a heat-reactivateable adhesive or a heat-seal adhesive.

4. The sheet as claimed in claim 3, wherein said adhesive of the face A of the strip comprises poly(vinyl acetate).

5. The sheet as claimed in claim 1, wherein said strip comprises an adhesive agent of low adhesive power on its face B.

6. The sheet as claimed in claim 5, wherein said sheet comprises a peeling starter, crosswise to the strip, having a depth equal to at least the thickness of the portion of the substrate covering the face A plus the thickness of said strip.

7. The sheet as claimed in claim 6, wherein said starter has a width equal to the width of said strip.

8. The sheet as claimed in claim 1, wherein said sheet comprises a peeling tab for peeling said strip.

9. The sheet as claimed in claim 8, wherein said tab is an adhesive-coated part placed on said strip.

10. The sheet as claimed in claim 1, wherein said strip extends from one edge to the other of said sheet.

11. The sheet as claimed in claim 1, wherein said strip and/or said substrate has a fibrous composition based on cellulose fibers.

12. The sheet as claimed in claim 1, wherein said substrate and said strip are based on the same fibers.

13. The sheet as claimed in claim 1, wherein said strip has more than 30% tensile strength when wet.

14. The sheet as claimed in claim 1, wherein said strip has a width of between 4 and 60 mm.

15. The sheet as claimed in claim 1, wherein said strip has a thickness of between 20 and 120 μm.

16. The sheet as claimed in claim 1, wherein said strip is opaque.

17. The sheet as claimed in claim 1, wherein said substrate comprises a fibrous single ply or several fibrous layers.

18. The sheet as claimed in claim 1, wherein said substrate is opaque.

19. The sheet as claimed in claim 1, wherein said sheet also comprises an opaque layer.

20. The sheet as claimed in claim 1, wherein it comprises another sheet material at least partly carrying said item of information and assembled to said backing element so that said item of information is facing the face B of said strip.

21. The sheet as claimed in claim 20, wherein said sheet material is laminated to said backing element with an adhesive.

22. The sheet as claimed in claim 20, wherein said sheet material is a fibrous sheet.

23. The sheet as claimed in claim 1, wherein said strip and/or said substrate and/or said sheet material, and/or the peeling tab comprises at least one security element.

24. A method for manufacturing a security sheet as described in claim 1, comprising at least one item of information and a backing element, into which a strip is incorporated, having a face A and a face B, that can be peeled along said face B, said item of information being carried by and/or facing said face B, which method being such that the sheet is formed by a paper-making method and which comprises the following steps:
in a first step, the strip is manufactured,
in a second step, said backing element is manufactured according to a paper-making method, by inserting said strip partly wet into said substrate in formation.

25. The manufacturing method as claimed in claim 24, wherein the strip is fibrous.

26. The manufacturing method as claimed in claim 24, wherein the substrate is fibrous.

27. The manufacturing method as claimed in claim 24, wherein said strip is inserted en masse partly wet, on a paper machine fitted with at least one round form, into the form tank of said round form and before or shortly after the beginning of the draining of said substrate in formation.

28. The manufacturing method as claimed in claim 24, wherein said substrate comprises at least two successive fibrous plies and in that said strip is inserted partly wet between these two successive plies and before their assembly in the wet state.

29. The manufacturing method as claimed in claim 24, wherein said strip is incorporated by lamination between two fibrous layers of said substrate of said sheet.

30. The manufacturing method for said sheet as claimed in claim 24, wherein a zone is cut crosswise in at least the thickness of the portion of the substrate covering the face A of said strip and up to the whole of the thickness of said strip in order to create a peeling starter.

31. The manufacturing method for said sheet as claimed in claim 30, wherein said zone is cut by cutting with a knife.

32. The manufacturing method for said sheet as claimed in claim 30, wherein an adhesive-coated part is applied to the peeling starter in order to make a peeling tab.

33. The manufacturing method for said sheet as claimed in claim 24, wherein, in the first step, the strip is manufactured by forming a fibrous sheet in a paper-making manner from a suspension of fibers, a composition of a heat-reactivateable adhesive or a heat-seal adhesive is applied to one of the faces of said fibrous sheet, the sheet is dried, it is cut into strips, the face with said adhesive forming the face A of said strip and the other face forming its face B.

34. The manufacturing method as claimed in claim 33, wherein an adhesive agent with low adhesive power is applied, before or after the coating of said adhesive, to the face of the sheet opposite to the face receiving said adhesive, so that thereafter the level of cohesion Cb between the face B of the strip and the substrate is less than the level of cohesion Ca between the face A of the strip and the substrate.

35. The manufacturing method for said sheet as claimed in claim 33, wherein said item of information is printed on the face B of the strip.

36. The manufacturing method for said sheet as claimed in claim 24, wherein an opaque layer is applied to at least one of the faces of the backing element.

37. The manufacturing method for said sheet as claimed in claim 24, wherein said item of information is at least partly printed onto another opaque sheet material and in that said sheet material is laminated with the substrate-strip backing element so that the face B of said strip is facing said item of information.

38. A security document or article comprising a security sheet with an item of information to be revealed, wherein said security sheet is a sheet comprising a strip that can be peeled as described in claim 1.

39. The security document or article as claimed in claim 38, wherein it is chosen from a gaming ticket, a sheet or an envelope with acknowledgement of receipt, a security label, a packaging element, for cosmetics or perfumes or for electronic parts or for spare parts, a sheet used in the medical or hospital field.

40. A method for revealing a masked item of information of a security document or of an article, wherein a document or article is used comprising a peelable strip as described in claim 38 and in that said strip is peeled off by separating it from the substrate at its face B and then the item of information is read on the strip and/or on a zone of the document or article that is facing said strip.
